(19) United States
(12) Patent Application Publication
(10) Pub. No.: US 2007/0108906 A1
(43) Pub. Date: May 17, 2007

(54) Plasma display panel (PDP) and plasma display apparatus including the PDP

(76) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/595,471

(22) Filed: Nov. 9, 2006

(30) Foreign Application Priority Data
Nov. 12, 2005 (KR) 10-2005-0108297

(51) Int. Cl. H01J 17/49

(52) U.S. Cl. 313/582

(57) ABSTRACT

A plasma display panel (PDP) that improves a transmittance rate of visible rays, prevents address electrodes from producing a lot of heat, and reduces the occurrence of afterimages from the PDP, and a plasma display apparatus using the PDP are provided. The PDP includes: a substrate through which visible rays displaying an image are transmitted; a plurality of electrode buried walls arranged below the substrate and defining discharge cells; a plurality of pairs of discharge electrodes spaced apart from each other in the electrode buried walls and performing a discharge in the discharge cells; a sealing member arranged below the electrode buried walls, sealing a discharge gas together with the substrate, and formed of a material having a higher thermal conductivity than that of the substrate; and phosphor layers arranged in the discharge cells.

### CROSS-REFERENCE TO RELATED PATENT APPLICATION

This application claims the benefits of Korean Patent Application No. 10-2005-0108297, filed on Nov. 12, 2005, in the Korean Intellectual Property Office, the disclosure of which is incorporated herein in its entirety by reference.

### BACKGROUND OF THE INVENTION

1. Field of the Invention

The present embodiments relate to a plasma display panel (PDP) and a plasma display apparatus including the PDP, more particularly, to a PDP that displays an image using a plasma discharge and a plasma display apparatus including the PDP.

2. Description of the Related Art

Plasma display panels (PDP) which have replaced conventional cathode ray tube (CRT) display devices display desired images using visible rays generated by sealing discharge gas and applying discharge voltage between two substrates on which a plurality of electrodes are formed to generate vacuum ultraviolet rays and exciting phosphor on which the vacuum ultraviolet rays are formed in a predetermined pattern.

FIG. 1 is a partially exploded perspective view of a conventional PDP 100. The PDP 100 includes a front substrate 101, a plurality of pairs of sustain electrodes including scan electrodes 106 and sustain electrodes 107 arranged on the front substrate 101, a front dielectric layer 109 formed on the plurality of pairs of sustain electrodes 106 and 107, a protective layer 111 formed on the front dielectric layer 109, a rear substrate 115 facing the front substrate 101, address electrodes 117 arranged in the rear substrate 115, a rear dielectric layer 113 formed on the address electrodes 117, barrier ribs 114 formed on the rear dielectric layer 113, and phosphor layers 110 formed on the upper surface of the rear dielectric layer 113 and sidewalls of the barrier ribs 114.

In general, the front substrate 101 and the rear substrate 115 can be formed of a glass material such as PD-200 or soda-lime. However, each of the front substrate 101 and the rear substrate 115 of the PDP 100 are formed of a glass material with a thickness of several millimeters. The glass substrate is heavy and expensive. Nevertheless, the front substrate 101 and the rear substrate 115, on which the pairs of sustain electrodes 106 and 107 and the address electrodes 117 are formed, respectively, must be formed of the glass material.

Also, the PDP 100 has high temperature discharge spaces due to a high voltage, so that charged particles are excessively produced in the discharge spaces. The charged particles collide with a phosphor substance, resulting in a deterioration of the phosphor substance and causing an afterimage on a screen. Therefore, it is necessary to externally dissipate heat generated by the pairs of sustain electrodes 106 and 107. However, the glass materials used to form the front substrate 101 do not have a good thermal conductivity, thus causing afterimages on the screen.

### SUMMARY OF THE INVENTION

The present embodiments provide a plasma display panel (PDP) having a reduced cost and weight.

The present embodiments also provide a PDP for preventing a temperature of the PDP from increasing.

The present embodiments also provide a PDP having a simple manufacturing process.

The present embodiments also provide a PDP for improving a discharge area and brightness.

The present embodiments also provide a plasma display apparatus including the PDP.

According to an aspect of the present embodiments, there is provided a plasma display panel (PDP) comprising: a substrate through which visible rays displaying an image are transmitted; a plurality of electrode buried walls arranged below the substrate and defining discharge cells; a plurality of pairs of discharge electrodes in the electrode buried walls and performing a discharge in the discharge cells; a sealing member arranged below the electrode buried walls, sealing a discharge gas together with the substrate, and formed of a material having a higher thermal conductivity than that of the substrate; and phosphor layers arranged in the discharge cells.

The sealing member may have a thermal conductivity equal to or higher than that of the electrode buried walls.

The sealing member may comprise a substance selected from the group consisting of aluminous materials, Si₃N₄, and BeO.

The sealing member may comprise from about 20 wt % to about 70 wt % of the substance.

The sealing member may comprise an e-GRAF material.

The sealing member may comprise the same material as that of the electrode buried walls.

The sealing member and the electrode buried walls may be integrally formed with each other in a body.

Each of the pairs of discharge electrodes may comprise a first discharge electrode and a second discharge electrode that cross each other.

The PDP may further comprise: address electrodes crossing the pairs of discharge electrodes that comprise first discharge electrodes and second discharge electrodes that extend in a predetermined direction.

The address electrodes may be spaced apart from the first and second discharge electrodes by a predetermined distance and are arranged in the electrode buried walls.

The PDP may further comprise: protective layers covering the sidewalls of the electrode buried walls corresponding to the discharge cells and the upper surface of the sealing member.

Grooves having a specific depth are formed in the transparent substrate in each of the discharge cells, and the phosphor layers are arranged inside the grooves.

The PDP may further comprise: protective layers covering the sidewalls of the electrode buried walls.

According to an aspect of the present embodiments, there is provided a PDP comprising: a substrate through which visible rays displaying an image are transmitted; a plurality of electrode buried walls arranged below the substrate and defining discharge cells; a plurality of pairs of discharge electrodes in the electrode buried walls and performing a discharge in the discharge cells; a sealing member arranged below the electrode buried walls, sealing a discharge gas together with the substrate, and formed of a material having a higher thermal conductivity than that of the substrate; a dielectric layer formed between the sealing member and the electrode buried walls; address electrodes buried in the dielectric layer, and crossing the pairs of discharge electrodes; and phosphor layers arranged in the discharge cells.

The sealing member may have a thermal conductivity equal to or higher than that of the dielectric layer.

The dielectric layer may comprise the same material as that of the electrode buried walls.

The PDP may further comprise: protective layers covering the sidewalls of the electrode buried walls and the upper surface of the dielectric layer.

According to an aspect of the present embodiments, there is provided a plasma display apparatus comprising: a PDP comprising a substrate through which visible rays displaying an image are transmitted transmit; a plurality of electrode buried walls arranged below the substrate and defining discharge cells; a plurality of pairs of discharge electrodes in the electrode buried walls and performing a discharge in the discharge cells; a sealing member arranged below the electrode buried walls, sealing a discharge gas together with the substrate, and formed of a material having a higher thermal conductivity than that of the substrate; and phosphor layers arranged in the discharge cells; and a chassis on a surface of the sealing member opposite to a surface of a sealing member on which the electrode buried walls are disposed and supporting the PDP.

In another embodiment, the plasma display apparatus comprises a combination member combining a sealing member and a chassis which is interposed between the sealing member and the chassis.

Another embodiment relates to a plasma display apparatus comprising a PDP comprising a substrate through which visible rays displaying an image are transmitted transmit; a plurality of electrode buried walls arranged below the substrate and defining discharge cells; a plurality of pairs of discharge electrodes in the electrode buried walls and performing a discharge in the discharge cells; a sealing member arranged below the electrode buried walls, sealing a discharge gas together with the substrate, and formed of a material having a higher thermal conductivity than that of the substrate; phosphor layers arranged in the discharge cells; and a chassis on a surface of the sealing member opposite to a surface of a sealing member on which the electrode buried walls are disposed and supporting the PDP.

In another embodiment, the plasma display apparatus comprises a thermal conductive sheet interposed between the sealing member and the chassis in a region where the combination member is not arranged.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a partially exploded perspective view of a conventional plasma display panel (PDP);

FIG. 2 is a partially exploded perspective view of a PDP according to an embodiment;

FIG. 3 is a cross-sectional view of the PDP of FIG. 2 taken along a line III-III in FIG. 2 according to an embodiment;

FIG. 4 schematically illustrates discharge cells and first and second discharge electrodes illustrated in FIG. 2 according to an embodiment;

FIG. 5 is a diagram illustrating a method of manufacturing the PDP illustrated in FIG. 2;

FIG. 6 is a cross-sectional view of a 3D electrode type PDP according to an embodiment;

FIG. 7 schematically illustrates discharge cells, first and second discharge electrodes, and address electrodes illustrated in FIG. 6 according to an embodiment;

FIG. 8 is a partially exploded perspective view of a PDP according to another embodiment;

FIG. 9 is a cross-sectional view of the PDP of FIG. 8 taken along a line IX-IX in FIG. 8 according to an embodiment; and

FIG. 10 is a cross-sectional view of a plasma display apparatus according to an embodiment.

### DETAILED DESCRIPTION OF THE INVENTION

The present embodiments will now be described more fully with reference to the accompanying drawings, in which exemplary embodiments are shown.

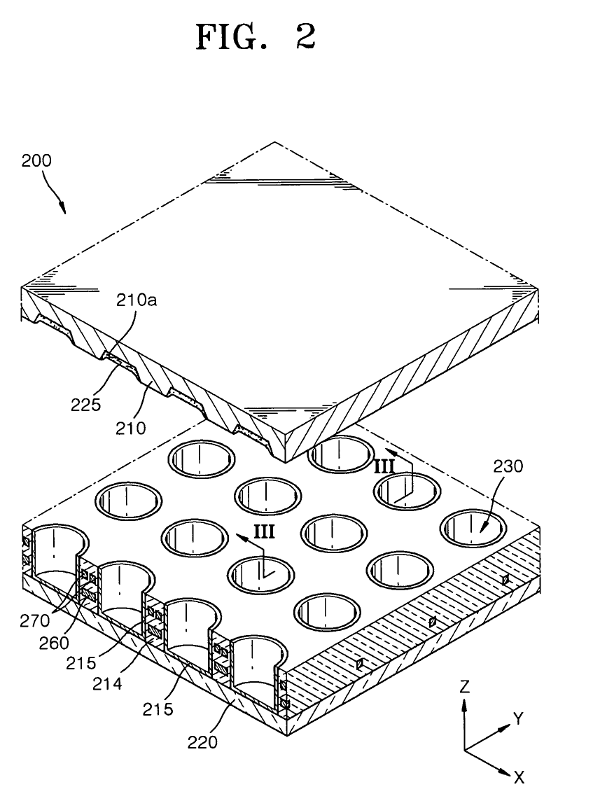

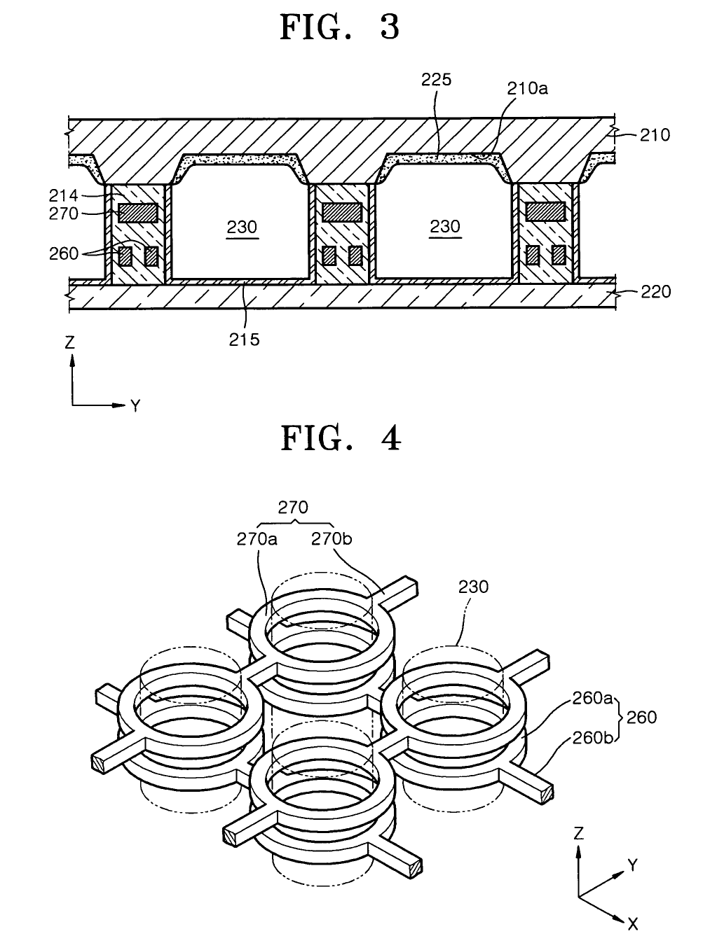

FIG. 2 is a partially exploded perspective view of a PDP 200 according to an embodiment. FIG. 3 is a cross-sectional view of the PDP of FIG. 2 taken along a line III-III in FIG. 2 according to an embodiment. FIG. 4 schematically illustrates discharge cells 230 and first and second discharge electrodes 260 and 270 illustrated in FIG. 2 according to an embodiment.

Referring to FIGS. 2 and 3, the PDP 200 comprises a transparent substrate 210, a sealing member 220, electrode buried walls 214, pairs of discharge electrodes 260 and 270, and phosphor layers 225.

Visible light for displaying an image is transmitted through the transparent substrate 210. Therefore, the transparent substrate 210 is formed of a high transparent material such as glass. The transparent substrate 210 can be colored in order to increase a bright room contrast by reducing a reflective brightness.

The sealing member 220 is spaced apart from the transparent substrate 210. A discharge gas is sealed between the sealing member 220 and the transparent substrate 210.

The electrode buried walls 214 are interposed between the transparent substrate 210 and the sealing member 220, define discharge cells 230, and prevent electrical and optical crosstalk between adjacent discharge cells 230. When a pulse voltage is applied to electrodes formed in the electrode buried walls 214, the electrode buried walls 214 induce charged particles and wall charges participating in a discharge, thereby operating the PDP 200 via a memory effect and preventing the PDP 200 from being damaged due to collisions of accelerating charged particles when the electrodes perform the discharge.

The electrode buried walls 214 can be formed of a glass material containing for example, an element such as Pb, B, Si, Al, O and mixtures thereof, and of a dielectric substance containing a filler such as, for example, ZrO₂, TiO₂, Al₂O₃ and mixtures thereof, and a pigment such as, for example, Cr, Cu, Co, Fe, TiO₂ and mixtures thereof.

In the current embodiment, the electrode buried walls 214 define the discharge cells 230 to have a circular cross-section. However, the present embodiments are not limited thereto. That is, the electrode buried walls 214 can define the discharge cells 230 having a variety of patterns. For example, the cross-sections of the discharge cells 230 can be polygonal such as hexagonal, octagonal, or oval, etc. Also, the electrode buried walls 214 can define the discharge cells 230 to have the shape of a delta or a waffle.

The pairs of discharge electrodes 260 and 270 are formed in the electrode buried walls 214 between each of the discharge cells 230. The pairs of discharge electrodes 260 and 270 can include first discharge electrodes 260 and second discharge electrodes 270 and perform the discharge.

Referring to FIG. 4, each of the first discharge electrodes 260 includes a first loop 260a surrounding each of the discharge cells 230 and a first loop connector 260b connecting the first loop 260a. Also, each of the second discharge electrodes 270 includes a second loop 270a surrounding each of the discharge cells 230 and a second loop connector 270b connecting the second loop 270a.

The first and second loops 260a and 270a are in the shape of a circular ring. However, the present embodiments are not limited thereto. The first and second loops 260a and 270a may have a variety of shapes such as a tetragon and may have the same shape as the cross-sections of the discharge cells 230.

The PDP 200 of the current embodiment can have a 2D structure. That is, either of the first discharge electrodes 260 or the second discharge electrodes 270 may serve as scan and sustain electrodes, and the others may serve as address and sustain electrodes.

In this case, the first loops 260a of the first discharge electrodes 260 extend in a first direction (a Y direction). The second discharge electrodes 270 surround the discharge cells 230 formed in a second direction (an X direction) crossing the first direction (the Y direction). The first and second discharge electrodes 260 and 270 can be spaced apart from each other vertically (a Z direction) in the electrode buried walls 214, and perpendicular to the transparent substrate 210. According to an embodiment, the second discharge electrodes 270 are formed closer to the transparent substrate 210 than the first discharge electrodes 260. However, the present embodiments are not limited thereto.

While the PDP 200 can have a 2D electrode (the first discharge electrode 260 and the second discharge electrode 270) structure according to the present embodiments, the present embodiments are not limited thereto and may also have a 3D electrode structure. This will be described in detail later.

Since the first and second discharge electrodes 260 and 270 are not formed to directly reduce a transmittance ratio of the visible light, they can be formed of a conductive metal such as Al, Cu, etc. Therefore, a voltage drop is small, thereby delivering a stable signal.

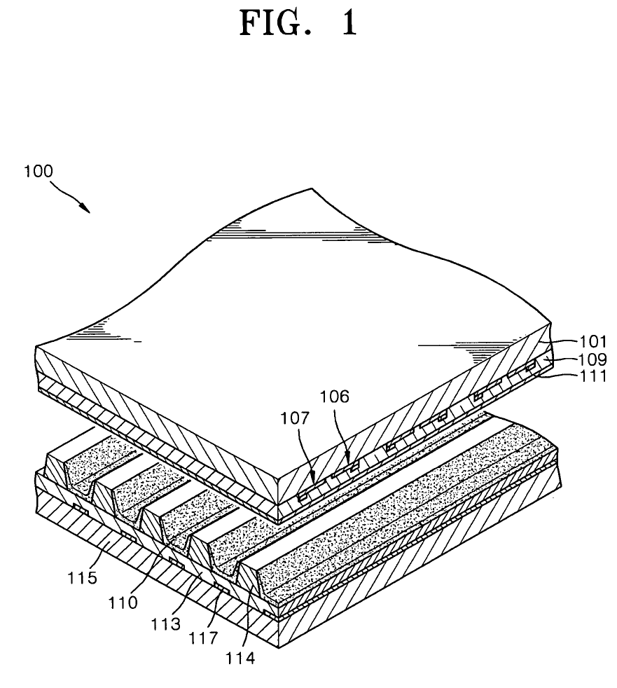

The transparent substrate 210 does not include the pairs of sustain electrodes 106 and 107, the front dielectric layer 109, and the protective layer 111, formed in the front substrate 101 of the conventional PDP 100 illustrated in FIG. 1 so that a forward transmittance ratio of the visible light can be increased. Therefore, when the PDP 200 displays an image having a conventional brightness, it can operate the first and second discharge electrodes 260 and 270 at a relatively low voltage.

The first and second discharge electrodes 260 and 270 are buried in the electrode buried walls 214. Therefore, the electrode buried walls 214 may be formed of a dielectric substance to prevent the adjacent first and second discharge electrodes 260 and 270 from directly conducting between them and from being damaged due to collisions between electrons and the first and second discharge electrodes 260 and 270 so as to induce charges and accumulate wall charges.

The sealing member 220 has a better thermal conductivity than the transparent substrate 210. That is, the transparent substrate 210 is formed of a glass material such as SiO₂, PbO, Bi₂O₃, etc. Therefore, the sealing member 220 is formed of a higher thermal conductivity than the glass material such as SiO₂, PbO, Bi₂O₃, etc.

By doing so, heat generated by the pairs of discharge electrodes 260 and 270 dissipates via the electrode buried walls 214 and the sealing member 220 which has a higher thermal conductivity than the rear substrate 115 of the conventional PDP 100 formed of the same material as the transparent substrate 210, thereby decreasing the temperature of the discharge cells 230, so that the image sticking produced due to the high temperature of the discharge cells 230 does not occur or is reduced.

According to an embodiment, the sealing member 220 may be formed of a dielectric substance having at least one of a group consisting of aluminous materials, Si₃N₄, and BeO because Si₃N₄, and BeO have a higher thermal conductivity than the glass materials as indicated in Table 1. The aluminous materials include Al-containing materials such as Al₂O₃, AlN, etc.

TABLE 1

| | Thermal Conductivity | Manufacturing |
|---|---|---|
| | (W/mK) | Temperature (° C.) |
| Al₂O₃ | 25 | 1500 |
| Si₃N₄ | 33 | 1500 |
| AiN | 230 | 1900 |
| BeO | 290 | 2000 |
| Borosilicate glass | 2 | 800 |
| Glass-ceramic | 5 | 950 |

According to an embodiment, the sealing member 220 may be formed of from about 20 wt % to about 70 wt % of at least one of the group consisting of aluminous materials, Si₃N₄, and BeO.

Otherwise, the sealing member 220 can be formed of a dielectric substance containing an eGRAF® (GrafTech International Ltd., Parma, Ohio) material.

The sealing member 220 may have the same thermal conductivity as the electrode buried walls 214, or a higher thermal conductivity than the electrode buried walls 214. The electrode buried walls 214 can be formed of a glass material containing an element such as, for example, Pb, B, Si, Al, O and mixtures thereof, and a dielectric substance containing a filler such as, for example, ZrO₂, TiO₂, Al₂O₃ and mixtures thereof, and a pigment such as, for example, Cr, Cu, Co, Fe, TiO₂ and mixtures thereof. The sealing member 220 may be formed of a material having the same thermal conductivity as the materials or a higher thermal conductivity than the materials.

The sealing member 220 can be formed of a material having the same thermal conductivity as the electrode buried walls 214, so that the sealing member 220 and the electrode buried walls 214 can be integrally formed with each other in a body, thereby simplifying a manufacturing process.

Meanwhile, the protective layers 215 can be formed on the sealing member 220 and the sidewalls of the electrode buried walls 214 that are exposed to the discharge cells 230. The protective layers 215 that are formed via a sputtering of plasma particles prevent the electrode buried walls 214 and the first and second discharge electrodes 260 and 270 from being damaged, and emit secondary electrons and reduce a discharge voltage. The protective layers 215 formed to have a specific thickness of magnesium oxide (MgO) are formed in portions of the side surfaces of the electrode buried walls 214.

First grooves 210a having a specific depth are formed on the transparent substrate 210 facing each of the discharge cells 230. The first grooves 210a are irregularly formed in each of the discharge cells 230. The phosphor layers 225 are arranged in the first grooves 210a. However, the arrangement of the phosphor layers 225 of the present embodiments is not limited thereto. For example, the phosphor layers 225 can be arranged on the sidewalls of the electrode buried walls 214 in which the protective layers 215 are not formed.

The phosphor layers 225 have a component generating visible rays with ultraviolet rays. That is, a phosphor layer formed in a red light emitting a discharge cell has a phosphor such as Y(V,P)O₄:Eu, a phosphor layer formed in a green light emitting a discharge cell has a phosphor such as Zn₂SiO₄:Mn, YBO₃:Tb, and a phosphor layer formed in a blue light emitting discharge cell has a phosphor such as BAM:Eu.

A discharge gas such as, for example, Ne, Xe, or a mixture thereof is filled into the discharge cells 230. In the current embodiment, a discharge area is increased and a discharge region is expanded due to the first grooves 210, which increases the amount of plasma, and thereby the PDP 200 can be operated at a low voltage. Therefore, although a gas Xe having a high density can be used as the discharge gas, the PDP 200 can be operated at a low voltage, thereby considerably increasing luminous efficiency.

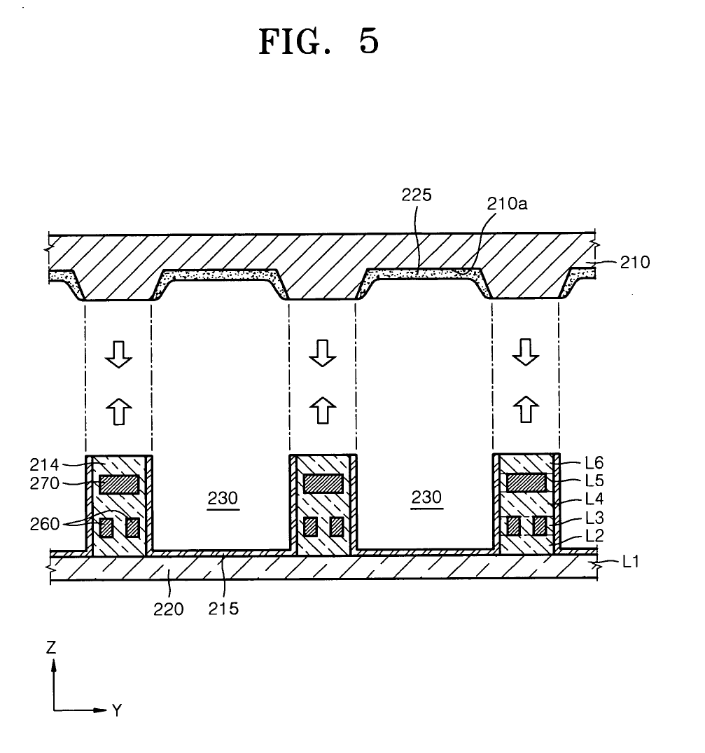

A method of manufacturing the PDP 200 will now be described with reference to FIG. 5.

FIG. 5 is a diagram for illustrating a method of manufacturing the PDP 200 illustrated in FIG. 2 according to an embodiment. Referring to FIG. 5, a substantially flat transparent substrate 210 is formed using etching or sand blasting and first grooves 210a are formed in the transparent substrate 210. Phosphor layer pastes are coated in the first grooves 210a and dried and baked to form the phosphor layers 225.

Sheets for a sealing member 220 and electrode buried walls 214 are formed simultaneously with the above process. The sheets for the electrode buried walls 214 include the electrode buried walls 214, the first and second discharge electrodes 260 and 270, and a protective layer 215.

A second dielectric sheet L2 is formed and stacked on the sheet L1 for the sealing member 220 to form the electrode buried walls 214. A third dielectric sheet L3 in which the first discharge electrodes 260 are patterned is formed on the second dielectric sheet L2. A fourth dielectric sheet L4 is formed on the third dielectric sheet L3. A fifth dielectric sheet L5 in which the second discharge electrodes 270 are patterned is formed on the fourth dielectric sheet L4. The sixth dielectric sheet L6 is formed on the fifth dielectric sheet L5. After the second through sixth dielectric sheets L2˜L6 are formed on the first dielectric sheet L1, the discharge cells 230 for discharge spaces are formed by punching or drilling process. The first through sixth dielectric sheets L1˜L6 are arranged to form the electrode buried walls 214 and the sealing member 220 via a drying and baking process.

MgO is sputtered to form the protective layers 215. Each of the second through sixth dielectric sheets L2˜L6 is a single sheet. However, the present embodiments are not limited thereto. Each of the second through sixth dielectric sheets L2˜L6 can be formed of plurality sheets.

The transparent substrate 210 and the sealing member 220 are aligned to perform a sealing process using a frit, etc. An exhaust gas and a discharge gas are continuously injected to fabricate the PDP 200. Thereafter, a variety of post-processes such as aging can be performed.

The electrode buried walls 214 and the sealing member 220 of the PDP 200 can be integrally formed with each other in a body, and a similar process can be separately performed, thereby easily manufacturing the PDP 200.

A method of operating the PDP 200 will now be described.

An address discharge is performed between the first discharge electrodes 260 and the second discharge electrodes 270 to select one of the discharge cells 230 in which a sustain discharge is performed. A sustain voltage is applied to the first and second discharge electrodes 260 and 270 of the selected discharge cell 230 so that the sustain discharge is performed between the first discharge electrodes 260 and the second discharge electrodes 270. Thus, an energy level of an excited discharge gas is reduced and ultraviolet rays are emitted. The ultraviolet rays excite the phosphor layers 225 so that an energy level of the excited phosphor layers 225 is reduced to emit visible light. The emitted visible light forms an image.

In the conventional PDP 100, a sustain discharge is perpendicularly performed between the sustain electrodes 106 and 107, thereby relatively reducing a discharge area. However, the sustain discharge of the PDP 200 is performed with respect to all regions of the discharge cells 230, thereby relatively increasing the discharge area.

The sustain discharge of the PDP 200 forms a closed curve according to the sidewalls of the discharge cells 230 and extends to the center of the discharge cells 230. Therefore, the area where the sustain discharge is performed is increased and space charges inside the discharge cells 230 which are not used in the conventional PDP 100 assist in emitting light, thereby increasing the luminous efficiency of the PDP 200. In particular, since the discharge cells 230 of the current embodiment have circular cross-sections, the sustain discharge is uniformly performed with respect to all regions of the discharge cells 230.

Since the sustain discharge is performed in the center of the discharge cells 230, ion-sputtering of a phosphor substance due to charged particles, which is a problem of the conventional PDP 100, is prevented, so that a permanent image sticking is not formed although an image is displayed for a long time.

High heat generated by applying a voltage to the first and second discharge electrodes 260 and 270 during the sustain discharge can be dissipated via the electrode buried walls 214 and the sealing member 220, thereby reducing panel temperature and reducing the afterimage.

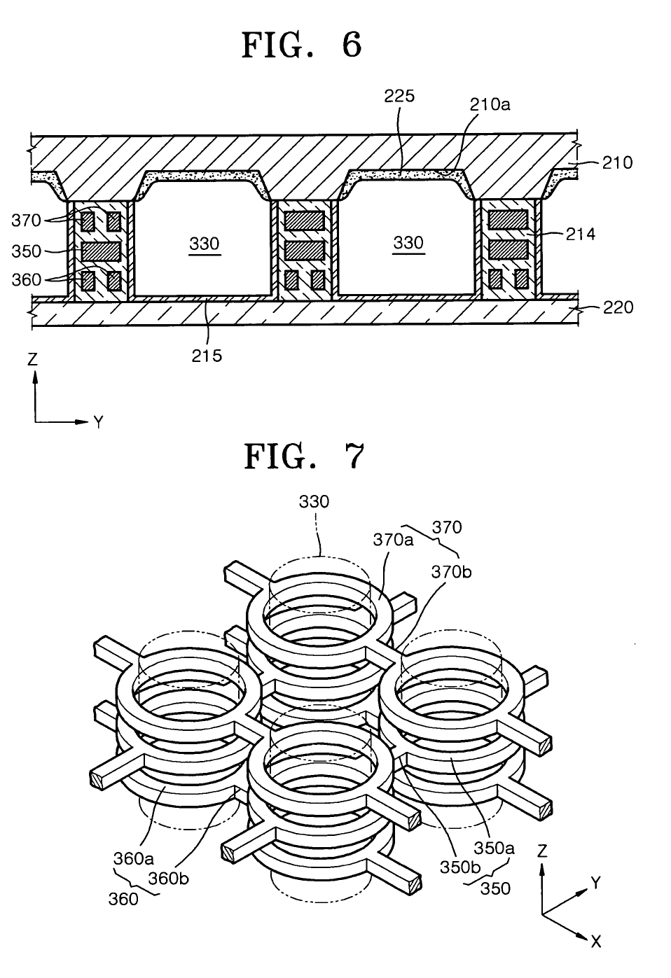

FIG. 6 is a cross-sectional view of a 3D electrode type PDP according to an embodiment;

FIG. 7 schematically illustrates discharge cells, first and second discharge electrodes, and address electrodes illustrated in FIG. 6 according to an embodiment. Like reference numerals in the drawings denote like elements. The 3D electrode type PDP includes first discharge electrodes 360, second discharge electrodes 370, and address electrodes 350 in electrode buried walls 214.

More specifically, the first discharge electrodes 360 and the second discharge electrodes 370 perform a discharge in the discharge cells 330 and extend in a predetermined direction. Each of the first discharge electrodes 360 includes a first loop 360a surrounding each of the discharge cells 330 arranged in a first direction (X direction) and a first loop connector 360b connecting the first loop 360a. Also, each of the second discharge electrodes 370 includes a second loop 370a surrounding each of the discharge cells 330 and a second loop connector 370b connecting the second loop 370a.

The address electrodes 350 extend to cross the first and second discharge electrodes 360 and 370. The address electrodes 350 are spaced apart vertically from (z direction) from the first and second discharge electrodes 360 and 370 in the electrode buried walls 214, and substantially perpendicular to the transparent substrate 210 . Each of the address electrodes 350 includes a third loop 350a surrounding each of the discharge cells 330 and a third loop connector 350b connecting the third loop 350a.

The second discharge electrodes 370, the address electrodes 350, and the first discharge electrodes 360 are sequentially arranged in a vertical direction perpendicular to the transparent substrate 210 in order to reduce an address discharge voltage. However, the present embodiments are not limited thereto. The address electrodes 350 can be arranged closest to or farthest from the transparent substrate 210, or formed on the sealing member 220.

The address electrodes 350 perform an address discharge in order to facilitate a sustain discharge between the first and second discharge electrodes 360 and 370 and more particularly, to reduce a voltage used to start the sustain discharge. The address discharge is performed between a scan electrode and an address electrode. When the address discharge ends, positive ions are accumulated on the scan electrode, and electrons are accumulated on a common electrode, thereby facilitating the sustain discharge between the scan electrode and the common electrode. In the current embodiment, the first discharge electrodes 360 serve as the scan electrode, and the second discharge electrodes 370 serve as the command electrode. However, the present embodiments are not limited thereto.

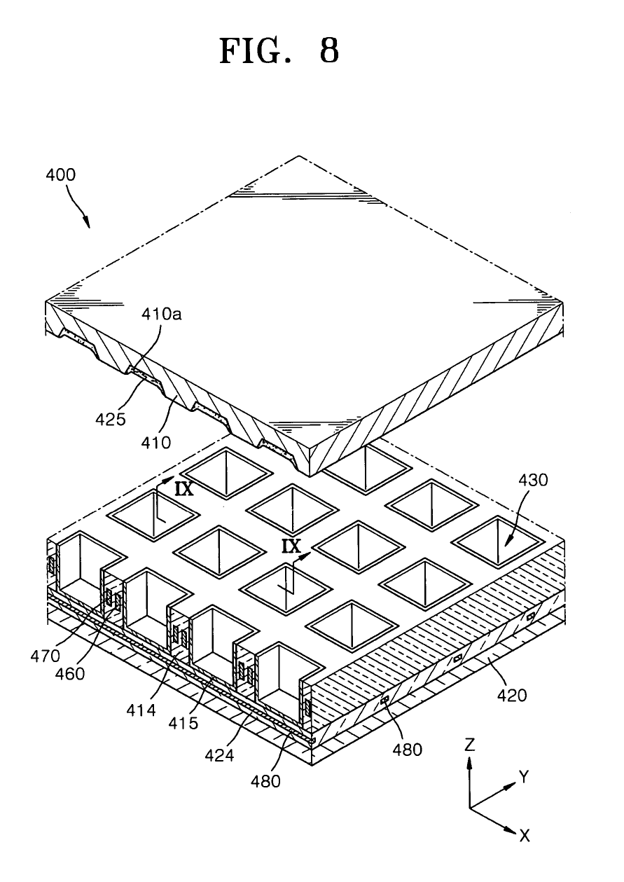

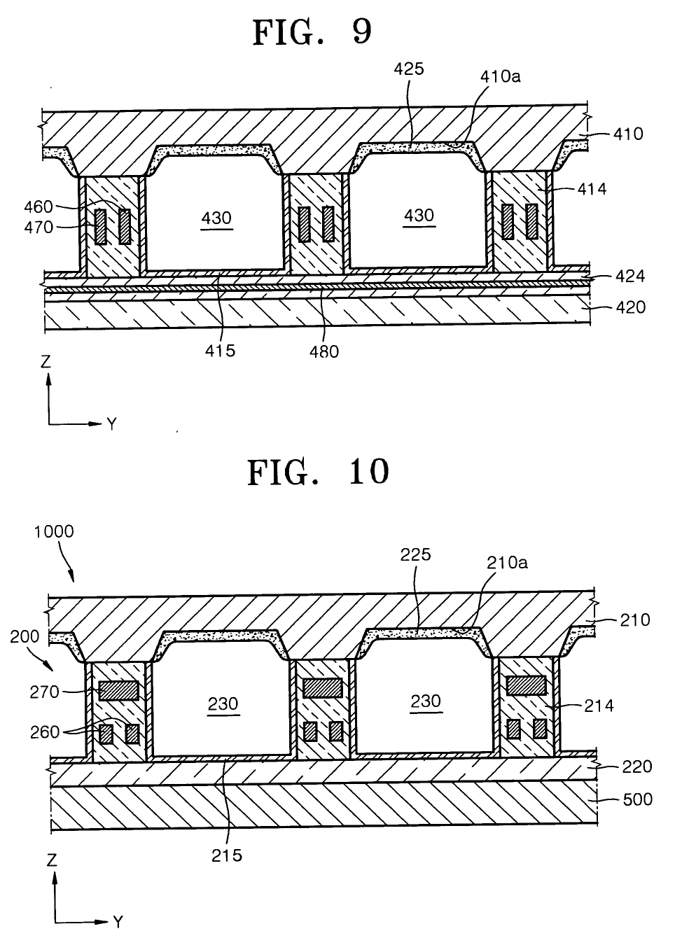

FIG. 8 is a partially exploded perspective view of a PDP 400 according to another embodiment. FIG. 9 is a cross-sectional view of the PDP of FIG. 8 taken along a line IX-IX in FIG. 8 according to an embodiment.

Referring to FIGS. 8 and 9, the PDP 400 comprises a transparent substrate 410, a sealing member 420, electrode buried walls 414, first discharge electrodes 460, second discharge electrodes 470, a dielectric layer 424, address electrodes 480, and phosphor layers 425. The PDP 400 further comprises a protective layer 415.

The PDP 400 of the current embodiment is different from the PDP 200 of the previous embodiment in that the dielectric layer 424 is interposed between the sealing member 420 and the electrode buried walls 414, and the address electrodes 480 are buried in the dielectric layer 424.

The first and second discharge electrodes 460 and 470 of the PDP 400 can have the same surface discharge structure as that of the PDP 200, or can have an opposing discharge structure. Therefore, an opposing discharge type PDP 400 and the dielectric layer 424 will now be described.

The transparent substrate 410 is formed of a high transparent material such as glass. The transparent substrate 410 can be colored in order to increase a bright room contrast by reducing a reflective brightness.

The electrode buried walls 414 are formed on the transparent substrate 410 to define discharge cells 430, and prevent electrical and optical crosstalk between adjacent discharge cells 430. In the current embodiment, the discharge cells 430 are formed to have tetragonal cross-sections. However, the present embodiments are not limited thereto.

The sealing member 420 is arranged in the below the electrode buried wall 414 to seal the discharge cells 430. The dielectric layer 424 is interposed between the electrode buried walls 414 and the sealing member 420. The dielectric layer 424 may contact the lower surface of the electrode buried walls 414. The dielectric layer 424 can be formed of various materials and may be formed of a dielectric substance. The dielectric layer 424 may be formed of the same material as that of the electrode buried walls 414.

The sealing member 420 has a higher thermal conductivity than the transparent substrate 410. The sealing member 420 may be formed of a dielectric substance having at least one of a group consisting of aluminous materials, Si₃N₄, and BeO. In this case, the sealing member 420 may be formed of from about 20 wt % to about 70 wt % of at least one of the group consisting of aluminous materials, Si₃N₄, and BeO. Otherwise, the sealing member 420 can be formed of a dielectric substance containing an eGRAF® material. The sealing member 420 is the same as the sealing member 220, and therefore a detailed description thereof is omitted.

The sealing member 420 may have the same thermal conductivity as the electrode buried walls 414, or a higher thermal conductivity than the electrode buried walls 414, so that heat generated from the pairs of discharge electrodes 460 and 470 and the address electrodes 480 can be easily dissipated via the dielectric layer 424 and the sealing member 420.

The first discharge electrodes 460 and the second discharge electrodes 470 are formed inside the electrode buried walls 414. The first discharge electrodes 460 and the second discharge electrodes 470 extend in a first direction (the Y direction in FIG. 8), and face each other toward the center thereof of the discharge cells 430. The first and second discharge electrodes 460 and 470 have the opposing discharge structure, so that a discharge can be uniformly performed in the discharge cells 430.

The address electrodes 480 extend in a second direction (the X direction in FIG. 8) cross the first and second discharge electrodes 460 and 470. In the current embodiment, the address electrodes 480 are arranged inside the dielectric layer 424 formed of a dielectric substance, thereby preventing discharge damage. The first discharge electrodes 460 serve as scan electrodes, and the second discharge electrodes 470 serve as common electrodes. However, the present embodiments are not limited thereto.

The first and second discharge electrodes 460 and 470 are buried in the electrode buried walls 414. Therefore, the electrode buried walls 414 may be formed of a dielectric substance to prevent the adjacent first and second discharge electrodes 460 and 470 from directly conducting and from being damaged due to collisions between electrons and the first and second discharge electrodes 460 and 470 so as to induce charges and accumulate wall charges.

The protective layers 415 can be formed on the dielectric layer 424 that is exposed to the sidewalls of the electrode buried walls 414 and the discharge cells 430. The protective layers 415 can be formed of MgO on portions of the surfaces of the electrode buried walls 414 corresponding to the discharge cells 430 and on portions of the surfaces of the dielectric layers 424 corresponding to the discharge cells. The protective layers 415 are formed to have a specific thickness and of MgO.

First grooves 410a having a specific depth are formed in portions of a bottom surface of the transparent substrate 410 facing each of the discharge cells 430. The first grooves 410a are irregularly formed in each of the discharge cells 430. The phosphor layers 425 are arranged in the first grooves 410a. The phosphor layers 425 were described in detail in the previous embodiment and thus a description thereof will be omitted.

A discharge gas such as, for example, Ne, Xe, or a mixture thereof is filled into the discharge cells 430.

The method of manufacturing the PDP 400 is similar to the method of manufacturing the PDP 200 and thus a description thereof will be omitted.

A method of operating the PDP 400 will now be described.

An address discharge is performed between the first discharge electrodes 460 and the address electrodes 480 to select one of the discharge cells 430 in which a sustain discharge is performed. A sustain voltage is applied to the first and second discharge electrodes 460 and 470 of the selected discharge cell 430 so that the sustain discharge is performed between the first discharge electrodes 460 and the second discharge electrodes 470. Thus, an energy level of an excited discharge gas is reduced and emits ultraviolet rays are emitted. The ultraviolet rays excite the phosphor layers 425 so that an energy level of the excited phosphor layers 425 is reduced to emit visible light. The emitted visible light forms an image.

FIG. 10 is a cross-sectional view of a plasma display apparatus 1000 according to another embodiment. The plasma display apparatus 1000 includes a chassis 500 formed on the bottom surface of a sealing member 220, similar to the sealing members 220 and 420 of the PDPs 200 and 400, respectively.

For descriptive convenience, the plasma display apparatus 1000 will now be described with reference to the PDP 200 and the chassis 500.

Referring to FIG. 10, the chassis 500 dissipates heat generated in the PDP 200 and supports the PDP 200. Driving portions (not shown) for operating the PDP 200 can be arranged at one side of the chassis 500.

Unlike conventional plasma display apparatuses, the plasma display apparatus 1000 does not need a rear substrate, so that the weight and manufacturing cost of the plasma display apparatus 1000 can be reduced. Also, it is easy to manufacture the plasma display apparatus 1000.

In the current embodiment, the PDP 200 and the chassis 500 do not contact each other. However, the present embodiments are not limited thereto. In detail, a thermal conductive sheet can be interposed between the sealing member 220 and the chassis 500 in order to dissipate the heat generated from the PDP 200 or transfer the heat to the chassis 500. Also, a adherence member such as double-sided tape can be interposed between the chassis 500 and the sealing member 220 in order to increase the mechanical fixing force between the PDP 200 and the chassis 500.

The effect of the present embodiments having the above design will now be described.

Electrodes that are conventionally arranged in a light path along which visible light passes are formed inside electrode buried walls, thereby reducing the number of constituents formed in a front substrate, considerably improving a transmittance rate of the visible light and increasing the brightness, and increasing a bright room contrast by preventing the external light from being reflected outwards.

Electrodes are formed of a material other than ITO, thereby reducing manufacturing costs of the electrodes, and easily increasing an area of a PDP. Also, since ITO does not need to be used, the manufacturing costs of the PDP can be reduced.

A discharge is performed in all discharge cells, the distance between a front discharge electrode and a rear discharge electrode is increased, and an operating voltage is reduced, thereby performing a lot of discharge at a low voltage. Therefore, an integrated circuit chip is operated at a low voltage, thereby reducing the manufacturing cost of the PDP.

Heat generated in pairs of discharge electrodes or address electrodes is externally dissipated, so that the temperature of the discharge cells is reduced, and image sticking does not occur or is reduced.

The PDP does not include a rear substrate, thereby reducing the weight and cost of the PDP.

Barrier ribs and a sealing member of the PDP can be integrally formed with each other in a body, thereby facilitating a manufacturing process of the PDP.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel (PDP) comprising:
a substrate through which visible rays displaying an image are transmitted;
a plurality of electrode buried walls arranged below the substrate and defining discharge cells;
a plurality of pairs of discharge electrodes in the electrode buried walls and performing a discharge in the discharge cells;
a sealing member arranged below the electrode buried walls, sealing a discharge gas together with the substrate, and formed of a material having a higher thermal conductivity than that of the substrate; and
phosphor layers arranged in the discharge cells.

2. The PDP of claim 1, wherein the sealing member has a thermal conductivity equal to or higher than that of the electrode buried walls.

3. The PDP of claim 1, wherein the sealing member comprises a substance selected from the group consisting of aluminous materials, Si₃N₄, and BeO.

4. The PDP of claim 3, wherein the sealing member comprises from about 20 wt % to about 70 wt % of the substance.

5. The PDP of claim 1, wherein the sealing member comprises an eGRAF® material.

6. The PDP of claim 1, wherein the sealing member comprises the same material as that of the electrode buried walls.

7. The PDP of claim 6, wherein the sealing member and the electrode buried walls are integrally formed with each other in a body.

8. The PDP of claim 1, wherein each of the pairs of discharge electrodes comprises a first discharge electrode and a second discharge electrode that cross each other.

9. The PDP of claim 1, further comprising: address electrodes crossing the pairs of discharge electrodes that comprise first discharge electrodes and second discharge electrodes that extend in a predetermined direction

10. The PDP of claim 9, wherein the address electrodes are spaced apart from the first and second discharge electrodes by a predetermined distance and are arranged in the electrode buried walls.

11. The PDP of claim 9, further comprising: protective layers covering the sidewalls of the electrode buried walls corresponding to the discharge cells and an upper surface of the sealing member.

12. The PDP of claim 1, wherein grooves having a specific depth are formed in the substrate in each of the discharge cells, and the phosphor layers are arranged inside the grooves.

13. The PDP of claim 1, further comprising: protective layers covering the sidewalls of the electrode buried walls.

14. A PDP comprising:
a substrate through which visible rays displaying an image are transmitted;
a plurality of electrode buried walls arranged below the substrate and defining discharge cells;
a plurality of pairs of discharge electrodes in the electrode buried walls and performing a discharge in the discharge cells;
a sealing member arranged below the electrode buried walls, sealing a discharge gas together with the substrate, and formed of a material having a higher thermal conductivity than that of the substrate;
a dielectric layer formed between the sealing member and the electrode buried walls;
address electrodes buried in the dielectric layer, and crossing the pairs of discharge electrodes; and
phosphor layers arranged in the discharge cells.

15. The PDP of claim 14, wherein the sealing member has a thermal conductivity equal to or higher than that of the dielectric layer.

16. The PDP of claim 14, wherein the sealing member comprises a substance selected from the group consisting of aluminous materials, Si₃N₄, and BeO.

17. The PDP of claim 16, wherein the sealing member comprises from about 20 wt % to about 70 wt % of the substance.

18. The PDP of claim 14, wherein the sealing member comprises an eGRAF® material.

19. The PDP of claim 14, wherein the dielectric layer comprises the same material as that of the electrode buried walls.

20. The PDP of claim 14, wherein grooves having a specific depth are formed in the substrate in each of the discharge cells, and the phosphor layers are arranged inside the grooves.

21. The PDP of claim 14, further comprising: protective layers covering the sidewalls of the electrode buried walls and an upper surface of the dielectric layer.

22. A plasma display apparatus comprising:
a PDP comprising a substrate through which visible rays displaying an image are transmitted transmit;
a plurality of electrode buried walls arranged below the substrate and defining discharge cells;
a plurality of pairs of discharge electrodes in the electrode buried walls and performing a discharge in the discharge cells;
a sealing member arranged below the electrode buried walls, sealing a discharge gas together with the substrate, and formed of a material having a higher thermal conductivity than that of the substrate;
phosphor layers arranged in the discharge cells; and
a chassis on a surface of the sealing member opposite to a surface of a sealing member on which the electrode buried walls are disposed and supporting the PDP.

23. The plasma display apparatus of claim 22, wherein a combination member combining the sealing member and the chassis is interposed between the sealing member and the chassis.

24. The plasma display apparatus of claim 23, wherein a thermal conductive sheet is interposed between the sealing member and the chassis in a region where the combination member is not arranged.
